(19) United States
(12) Patent Application Publication
(10) Pub. No.: US 2021/0018397 A1
(43) Pub. Date: Jan. 21, 2021

(54) IMPACT TESTING SYSTEM AND METHOD FOR OPERATING AN IMPACT TESTING SYSTEM

(71) Applicant: SIEMENS INDUSTRY SOFTWARE NV, Leuven (BE)

(72) Inventor: Xin Xin, Kampenhout (BE)

(21) Appl. No.: 17/041,862

(22) PCT Filed: Mar. 26, 2018
(86) PCT No.: PCT/EP2018/057667

§ 371 Date: Sep. 25, 2020

(51) Int. Cl. G01M 7/08; G01N 3/30

(52) U.S. Cl. CPC G01M 7/08; G01N 2203/0039; G01N 3/30

(57) ABSTRACT

An impact testing system includes an impact testing device with a head and a handle to which the head is affixed. The impact testing system also includes at least one vibration sensor. A method of using the impact testing device for automatically assessing impacts applied with the impact testing device to an object is also provided.

This application is the National Stage of International Application No. PCT/EP2018/057667, filed Mar. 26, 2018. The entire contents of this document is hereby incorporated herein by reference.

### FIELD

The present embodiments relate to the area of impact testing. More particularly, the present embodiments relate to impact testing performed on mechanical structures and parts thereof (e.g., unit under test (UUT)) for testing the dynamic behavior. Still more particularly, the present embodiments relate to impact testing on a vehicle body structure or parts thereof when, for example, applying kinematics & compliances scenarios (K&C scenarios) and/or an experimental modal analysis (EMA) in a test environment and for obtaining a frequency response, where the resulting frequency response is analyzed with a view to identifying potential weaknesses and/or for improving the rigidity of the relevant UUT.

### BACKGROUND

Impact testing is performed by a dedicated apparatus (e.g., a shaker) or by a modal hammer. A modal hammer is basically a regular hammer including a hammerhead (e.g., head) and a handle to which the head is attached. A modal hammer distinguishes over a regular hammer in that a modal hammer includes a force sensor.

Although a hammer is an ordinary tool, using a modal hammer for impact testing has proven to be a valid method. However, while using a modal hammer has certain advantages, using the modal hammer also involves various shortcomings. The advantages may be that: A modal hammer is cheap, at least considerably cheaper than a shaker; a modal hammer is easy to use and using a modal hammer does not require particular skills; and a modal hammer is lightweight and thus easy to be moved around when employed from different positions. Further, when impacting a structure with a modal hammer, the impacts may be applied at a wide frequency range, theoretically from a little over 0 Hz, which is not achievable by a shaker.

However, disadvantages for consideration when using a modal hammer for impact testing may be that: Often the space available for using a modal hammer is limited, which makes applying impacts difficult. Further, limited visibility conditions with or without space issues may impede that proper impacts are applied. Still further, impacts applied are normally not exactly repeatable for carrying out viable comparisons. Each impact is determined by the force applied (e.g., an offset; a distance between the modal hammer and the relevant UUT) and the angle under which the impact is applied. Misalignment in one or more of these parameters results in differing impacts and consequently differing impact results (e.g., excitations).

Resulting from what is summarized above, a modal hammer is employed as an impact testing device when less critical measurements are due or as a backup equipment. Whenever measurements requiring high accuracy (e.g., for determining transfer functions or strain frequency response function (FRF)) for load identification are to be performed, a modal hammer is a less preferable impact testing device.

However, there is still a need for providing a low-cost, ease-to-use instrument for impact testing.

From U.S. Pat. No. 6,748,791 B1 and EP 0 351 430 A1, it is respectively known to use a hammer equipped with a sensor to detect defects in a structure. From US 2016/0030815 A1 and GB 2 194061A, it is known to use a kind of sensor-hammer to determine pneumatic parameters from a tire or a game ball.

EP 0 141 013 A1 shows a hammer including a force-sensor. An impact-force may be measured after the force sensor was calibrated by a vibration sensor.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an impact testing system that improves upon a modal hammer, as described above, and includes at least one sensor for determining data and/or a value for at least one further parameter other than the parameter “force” when performing an impact test is provided.

More particularly, the present embodiments provide an impact testing device including a head (e.g., hammerhead) and a handle to which the head is affixed. The head carries at least one sensor (e.g., a vibration sensor) for providing data with respect to at least one further parameter when applying an impact while performing an impact test.

Another aspect of the present embodiments involves a method for operating an impact testing device as above or as described in more detail hereinafter.

With respect to the method, the present embodiments more particularly provide a method for operating an impact testing device as described above and hereinafter, where data obtained when applying an impact to a UUT is employed to automatically classify/assess the instant impact applied with the impact testing device as “good” (e.g., acceptable) or “bad” (e.g., inadequate; to be rejected) and/or where the obtained data is optionally recorded and being made available for comparisons.

Further aspects, features, and advantages of the present invention will become apparent from the drawings and detailed description of exemplary embodiments.

### BRIEF DESCRIPTION OF THE DRAWINGS

The above-mentioned and other concepts of the present invention will now be addressed with reference to the drawings of the preferred embodiment of the present invention. The shown embodiments are intended to illustrate, but not to limit the invention.

The drawings contain the following figures, in which like numbers refer to like parts throughout the description and drawings and wherein:

FIG. 1 shows one embodiment of an impact testing device;

FIG. 2 and FIG. 3 show an exemplary impact in the time domain and in the frequency domain;

FIG. 4 shows various exemplary vibration signals resulting from an impact applied to a UUT; and

FIG. 5 shows one embodiment of an impact testing system.

### DETAILED DESCRIPTION

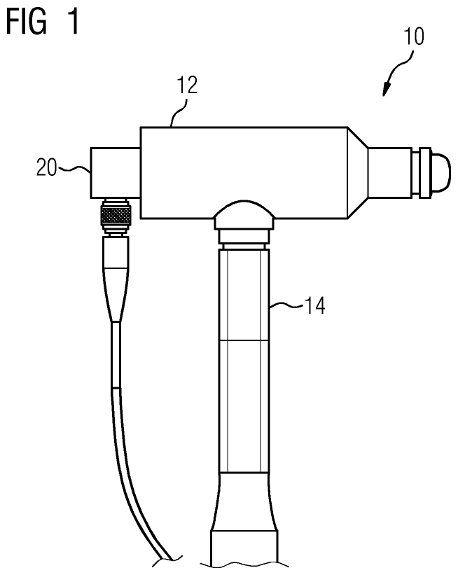

FIG. 1 shows one embodiment of an impact testing device 10. The impact testing device 10 is an improved form of a modal hammer known in the art. The subject impact testing device 10 features a head 12 and a handle 14 to which the head 12 is affixed. Owing to the form and the function of head 12 and the handle 14, the impact testing device 10 in the as yet described form is basically a conventional hammer.

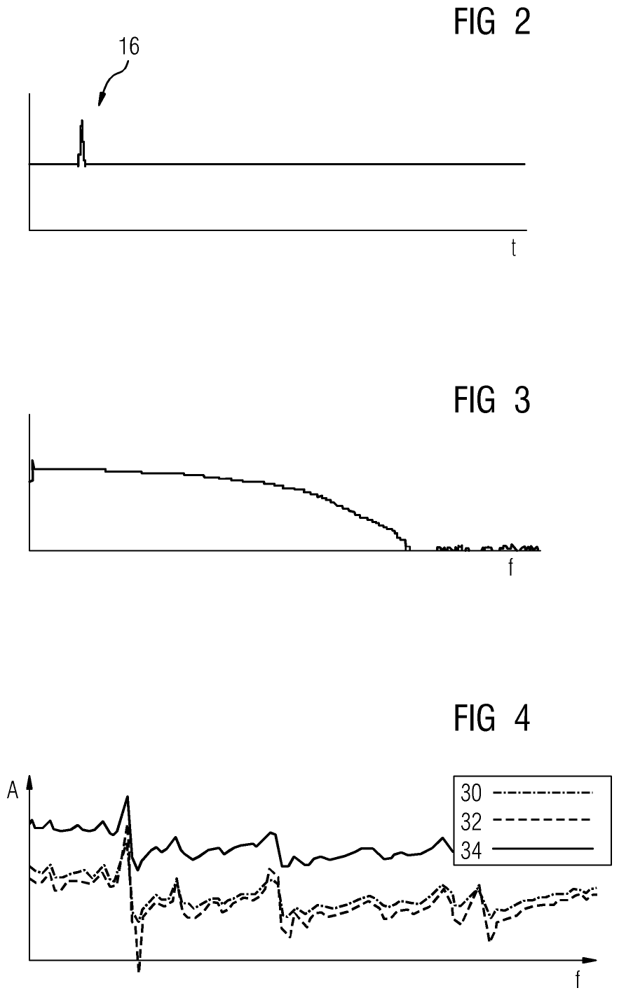

FIG. 2 and FIG. 3 show the results of an impact 16 applied by the impact testing device 10 of FIG. 1 on the relevant unit under test (UUT), the unit itself not being shown, in the time domain (FIG. 2) and in the frequency domain (FIG. 3). The graph in FIG. 3 shows an example frequency response resulting from applying an impact on the UUT.

The impact testing device 10 is a “smart hammer” on account of at least one vibration sensor 20 being attached to the head 12 or the handle 14.

In one embodiment, the vibration sensor 20 (or one sensor 20 of multiple sensors 20 attached to the impact testing device 10) is an accelerometer attached to the head 12 of the impact testing device 10 (e.g., to the back of the said head 12). Attaching the vibration sensor 20 to the back of the head 12 conveniently allows for employing a hole (e.g., a threaded hole) in the back of the head 12 when attaching the vibration sensor 20 to the head 12. The hole is originally provided for applying additional mass to the head 12, and consequently, the vibration sensor 20 may be attached to the head 12 without having to machine or even to modify the head 12.

A vibration sensor 20 in the form of an accelerometer allows direct sensing of the vibration of the impact testing device 10 resulting from applying an impact to the relevant UUT. It has been discovered that a misalignment in an angle under which the impact is applied is linked to unusual vibration of the impact testing device 10. Also, the force exercised when applying the impact is proportional to a resulting vibration of the impact testing device 10. A force too strong results in a stronger than expected vibration. Similarly, a force too weak results in a lower than expected vibration. Consequently, it was discovered that assessing an impact as properly applied and the resulting data as suitable for further processing may be assessed with a view to a bandwidth in the amplitude of the vibration measured by the accelerometer.

Illustrating the above, FIG. 4 shows three exemplary vibration signals 30, 32, 34. Each vibration signal 30, 32, 34 is an example for a vibration signal 30, 32, 34 obtained by the vibration sensor 20 following an impact applied to a UUT with an impact testing device 10. The impact testing device 10 is a “smart hammer,” as shown in FIG. 1, and the vibration sensor 20 may be an accelerometer. In the coordinate system, the frequency f is shown over the abscissa and the amplitude A over the ordinate. A first vibration signal 32 is discernible fairly similar to a reference vibration signal 30. Consequently, the impact 16, which causes the first vibration signal 32, may automatically be evaluated as an acceptable impact. However, an impact 16 resulting in a vibration signal 34 further apart from the reference vibration signal 30 or lacking sufficient similarity with the reference vibration signal 30 may also automatically be evaluated as inadequate, and the associated data (e.g., a frequency response obtained from the UUT) may automatically be discarded. Generally speaking, an impact 16 is inadequate and automatically assessed as such whenever the resulting vibration signal 32, 34 is lacking a predefined level of similarity with the reference vibration signal 30. This is exemplarily shown in FIG. 4 where the second vibration signal 34 is clearly dissimilar to the reference vibration signal 30.

In the shown example, the second vibration signal 34 is dissimilar to the reference vibration signal 30 on account of a much higher amplitude over the frequency spectrum. Consequently, an automatic assessment of the quality of an impact 16 may be carried out by comparing a predefined average value of the resulting vibration signal 32, 34 with a predefined or variable reference value, and whenever an absolute value of a difference of the aforesaid average value and reference value exceeds a predefined threshold (e.g., 5%), the impact 16 and data resulting therefrom is automatically discarded. In one embodiment, the average value is an average value representing unusual vibration levels in a certain frequency range in a direction other than the impact direction (e.g., a lateral direction). In an alternative embodiment, the automatic assessment of the quality of an impact 16 may be carried out by comparing (e.g., the arithmetic mean of the amplitudes of the resulting vibration signal 32, 34) with the arithmetic mean of the amplitudes of the reference vibration signal 30, and whenever an absolute value of a difference of the aforesaid arithmetic mean exceeds a predefined threshold (e.g., 5%), the impact 16 and data resulting therefrom is automatically discarded.

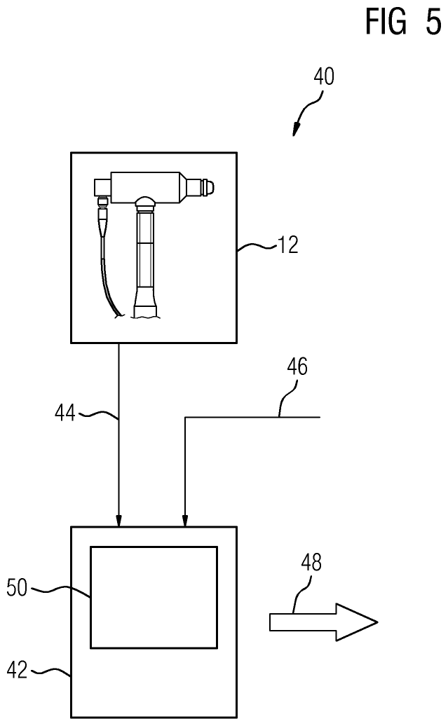

FIG. 5 shows one embodiment of an impact testing system 40. The impact testing system 40 includes at least one impact testing device 10 of the present embodiments. The impact testing system 40 further includes a processing unit 42 (e.g., a processor) communicatively linked to the at least one impact testing device 10.

The processing unit 42 is provided for assessing an impact 16 as acceptable or inadequate and is thus a way for assessing an impact 16 as acceptable or inadequate. Instant data 44 obtained from the at least one vibration sensor 20 (e.g., vibration data 44; vibration data 44 in the form of vibration signal(s) 32, 34; accelerometer data) is transferred via the communication link to the processing unit 42. The processing unit 42 is adapted to compare (as described above) the data 44 obtained from the at least one vibration sensor 20 with reference data 46 (e.g., the reference vibration signal 30), which is, for example, predefined, or tunable reference data 46, when assessing an impact 16 as acceptable or inadequate. The result of the comparison is an automatic assessment 48 pertaining to the impact 16 for which the instant data 44 was obtained, generated by a computer program 50 run by the processing unit 42. The assessment 48 is an automatically processable classification of the relevant impact 16 as acceptable or inadequate. Depending on the assessment 48, data resulting from the impact 16 is either further processed (e.g., in kinematics & compliances scenarios) or discarded. The further processing of data stemming from an impact 16 assessed as acceptable may be performed by the processing unit 42 or a further computerized system communicatively linked to the processing unit 42. Any such further computerized system receives the instant data and the assessment 48 pertaining thereto from the processing unit 42. The impact testing device 10 or multiple impact testing devices 10 and the processing unit 42 constitute the impact testing system 40.

In addition to the embodiment described above, those of skill in the art will be able to arrive at a variety of other arrangements and steps that, if not explicitly described in this document, nevertheless embody the principles of the invention and fall within the scope of the appended claims.

Briefly summarizing the above, this disclosure proposes an impact testing device 10 including a head 12 and a handle 14 to which the head 12 is affixed. The impact testing device further includes at least one vibration sensor 20. This disclosure further proposes a method of using the impact testing device 10 for automatically assessing impacts applied with the impact testing device 10 to the relevant UUT.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An impact testing system comprising:
a processor;
an impact testing device comprising a head and a handle to which the head is affixed; and
at least one vibration sensor communicatively coupled to the processor,
wherein the processor is configured to:
process data received from the at least one vibration sensor;
compare data obtained from the at least one vibration sensor with reference data; and
employ a result of the comparison for automatic assessment of an impact applied with the impact testing device, such that whether the impact is acceptable or inadequate is determined.

2. The impact testing system of claim 1, wherein one or more sensors of the at least one vibration sensor is attached to the head.

3. The impact testing system of claim 2, wherein the one or more sensors are attached to a back of the head.

4. The impact testing system of claim 3, wherein the one or more sensors are attached to the back of the head via a hole in the back of the head.

5. The impact testing system of claim 1, wherein the at least one vibration sensor or at least one sensor of a number of vibration sensors applied to the impact testing device is an accelerometer.

6. The impact testing system of claim 1, wherein the at least one vibration sensor or at least one sensor of a number of vibration sensors is configured to obtain vibration data resulting from the impact applied with the impact testing device.

7. A method for operating an impact testing system, the method comprising:
comparing data obtained from at least one vibration sensor with reference data;
comparing accelerometer data with the reference data; and
automatically assessing an impact applied with an impact testing device using a result of the comparing of the data obtained from the at least one vibration sensor with the reference data and a result of the comparing of the accelerometer data with the reference data, such that whether the impact is acceptable or inadequate is determined.

8. (canceled)

9. A non-transitory computer-readable storage medium that stores instructions executable by a processing unit of an impact testing system to operate the impact testing system, the instructions comprising:
comparing data obtained from at least one vibration sensor with reference data;
comparing accelerometer data with the reference data; and
automatically assessing an impact applied with an impact testing device using a result of the comparing of the data obtained from the at least one vibration sensor with the reference data and a result of the comparing of the accelerometer data with the reference data, such that whether the impact is acceptable or inadequate is determined.

10. The impact testing system of claim 4, wherein the at least one vibration sensor or at least one sensor of a number of vibration sensors applied to the impact testing device is an accelerometer.

11. The impact testing system of claim 4, wherein the at least one vibration sensor or at least one sensor of a number of vibration sensors is configured to obtain vibration data resulting from the impact applied with the impact testing device.

12. The impact testing system of claim 5, wherein the at least one vibration sensor or at least one sensor of a number of vibration sensors is configured to obtain vibration data resulting from the impact applied with the impact testing device.
